(19) United States
(12) Patent Application Publication
(10) Pub. No.: US 2024/0114352 A1
(43) Pub. Date: Apr. 4, 2024

(54) Domain Proxy Channel Reallocation Feature

(71) Applicant: Celona, Inc., Campbell, CA (US)

(72) Inventors: Sourav Bandyopadhyay, Liluah Howrah (IN); Srinivasan Balasubramanian, San Diego, CA (US); Aparna Jaiswal, Sunnyvale, CA (US); Mark Jan Dijkstra, Brooklyn, NY (US); Vinay Anneboina, San Jose, CA (US); Puneet Prabhakar Shetty; Mohit Goyal, Cupertino, CA (US)

(21) Appl. No.: 18/480,796

(22) Filed: Oct. 4, 2023

Related U.S. Application Data
(60) Provisional application No. 63/413,202, filed on Oct. 4, 2022.

(51) Int. Cl. H04W 16/18

(52) U.S. Cl. CPC H04W 16/18

(57) ABSTRACT

Steps are presented for deploying a plurality of BS/APs, such as CBSDs (Citizen's Broadband radio Service Devices) in an enterprise network or other such private network at a location such as a warehouse, factory, research center or other building. The deployment is a process by which the BS/APs in the network are set up to be ready for operation within the network. In addition, a communication system is described in which an enterprise operator provides subscription data and commissioning information to an SAS and a Subscriber Database.

### CLAIM OF PRIORITY TO PREVIOUSLY FILED PROVISIONAL APPLICATION—INCORPORATION BY REFERENCE

This non-provisional application claims priority to an earlier-filed provisional application No. 63/413,202 filed Oct. 4, 2022, entitled “Domain Proxy Channel Reallocation Feature” (ATTY DOCKET NO. CEL-095-PROV) and the provisional application No. 63/413,202 filed Oct. 4, 2022, and all its contents, are hereby incorporated by reference herein as if set forth in full.

### BACKGROUND

### (1) Technical Field

The disclosed method and apparatus relate generally to CBRS (Citizen Band Radio Systems) communication systems. In particular, the disclosed method and apparatus relates to a method and apparatus for managing DPAs (Dynamic Protection Area) events.

### (2) Background

FIG. 1 is an illustration of a basic configuration for a communication network 100, such as a “4G LTE” (fourth generation Long-Term Evolution) or “5G NR” (fifth generation New Radio) network, in which user equipment (UE) 101 communicates with a base station/access point (BS/AP) 103. One of the advantages of such networks is their ability to provide communications to and from multiple wireless devices and provide these wireless devices with access to a large number of other devices and services via the wireless connections to the BS/AP 103 of the network 100.

As used herein, the term “UE’ refers to a wide range of user_devices having wireless connectivity, such as a cellular mobile phone, an Internet of Things (IOT) device, virtual reality goggles, robotic devices, autonomous driving machines, smart barcode scanners, and communications equipment including for example cell phones, desktop computers, laptop computers, tablets and other types of personal communications devices. In some cases, the UEs may be mobile; in other cases they may be installed at a fixed location. For example, a factory sensor may be installed at a fixed location from which it can remotely monitor an assembly line or a robotic arm's movement.

Used herein, the term ‘BS/AP” is used broadly to include base stations and access points, including at least an eNB (extended NodeB) of an LTE/5G network, a cellular BS (base station), a CBSD (Citizens Broadband Radio Service Device) (which may be an LTE or 5G device), a WiFi access node, a LAN (Local Area Network) access point, a WAN (Wide Area Network) access point, and should also be understood to include other network receiving hubs that provide access to a network of a plurality of wireless transceivers within range of the BS/AP. Typically, the BS/APs are used as transceiver hubs, whereas the UEs are used for point to point communication and are not used as hubs. Therefore, the BS/APs transmit at a relatively higher power than the UEs.

The BS/APs provide the UEs with a connection to another network, which in this example is in the Core Network 105. One function of the Core Network 105 is to provide the UE 101 and the BS/AP 103 with access to other devices and services either within its network, or on other networks. Particularly, in cellular networks and in private networks, the BS/AP 103 can receive signals from, and send signals to, the UE 101. The BS/AP 103 is coupled to the core network 105. The BS/AP provides a connection that allows information to flow between the cellular or private network and other networks, such as the PSTN (Public Switched Telephone Network) or the Internet 107. Wireless data transmission between a UE 101 and the BS/AP 103 occurs on an assigned channel, such as a specific frequency. Data transmission between the BS/AP 103 and the Core Network 105 utilizes any appropriate communication means (e.g., wireless, cable, fiber optic, and so forth).

In addition to providing access to remote networks and allowing information to flow between the cellular network and the internet 107, the core network 105 provides control of the air interface between the base station 103 and the UEs 101. The Core Network 105 may also coordinate the BS/APs to minimize interference within the network.

The US Federal Government has provided rules (Rule 96) that allow general access to an area of the frequency spectrum referred to as the CBRS. CBRS, which is a useful element of an advanced communication network referred to as “5G”. CBRS operates in a 150 MHz wide frequency range from 3.55 GHz to 3.7 GHz. The CBRS rules set forth detailed requirements for the devices that operate in a CBRS network and how they communicate. CBRS supports both LTE and 5G devices. Base stations within a CBRS network are termed “CBSDs”, and UEs are termed EUDs (End User Devices). CBSDs are fixed Stations, or networks of such stations, that operate on a Priority Access or General Authorized Access basis in the CBRS consistent with Title 47 CFR Part 96 of the United States CFR (Code of Federal Regulations). For CBSDs that comprise multiple nodes or networks of nodes, CBSD requirements apply to each node, even if network management and communication with the a SAS (Spectrum Access System) is accomplished via a single network interface.

The CBRS rules require that the SAS allocate spectrum to the CBSDs to avoid interference within the CBRS band. Generally, the SAS authorizes and manages use of spectrum for the CBRS. More specifically, the SAS maintains records of all authorized services and CBSDs in the CBRS frequency bands, is capable of determining the available channel at a specific geographic location, provides information on available channels to CBSDs that have been certified under the Commission's equipment authorization procedures, determines and enforces maximum power levels for CBSDs, enforces protection criteria for Incumbent Users and Priority Access Licensees, and performs other functions as set forth in the FCC (Federal Communications Commission) rules.

The Spectrum Sharing Committee Work Group 3 (for CBRS Protocols) has established an interface specification for registering a CBSD, requesting a grant of spectrum, and maintaining that grant. These message flows are described in the document titled “Signaling Protocols and Procedures for CBRS: Spectrum Access System (SAS)—Citizens Broadband Radio Service Device (CBSD) Interface Technical Specification”, Document WINNF-TS-0016-V1.2.4. 26 Jun. 2019.

Communications in accordance with WINNF-TS-0016 between the CBSD, SAS and CPI (Certified Professional Installer) allow registration of CBSDs. A CPI is any individual trained and certified from an accredited CPI Training Program based on the relevant Part 96 of the CFR and associated technical best practices for the CBRS. In some embodiments, a DP (Domain Proxy) is substituted for individual CBSDs to efficiently handle messages from multiple CBSDs.

A.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of a basic configuration for a communication network, such as a “4G LTE” (fourth generation Long-Term Evolution) or “5G NR” (fifth generation New Radio) network, in which user equipment (UE) communicates with a base station/access point (BS/AP)

FIG. 2 is a flow diagram showing the communications that occur during registration.

FIG. 3 illustrates advantages of using a Domain Proxy.

FIG. 4 is a flow chart that illustrates steps to deploy a plurality of BS/APs such as CBSDs (Citizen's Broadband radio Service Devices) in an enterprise network in accordance with the CBRS (Citizens Broadband Radio Service) interface specification.

FIG. 5 is a diagram of a communication system in which an enterprise operator provides subscription data and commissioning information to an SAS and a Subscriber Database.

FIG. 6 is diagram that illustrates a plurality of BS/APs installed at an enterprise location.

FIG. 7 is a flow chart that details the process for taking REM measurements.

FIGS. 8A to 8E are a series of diagrams that show the round robin technique of taking REM measurements.

FIG. 9 is a simplified block diagram showing the architecture of the enterprise network of BS/APs.

FIG. 10 represents the relationship between CSBDs of one or more enterprise networks.

FIG. 11 is an illustration of a second scenario in which channel B{6} is suspended.

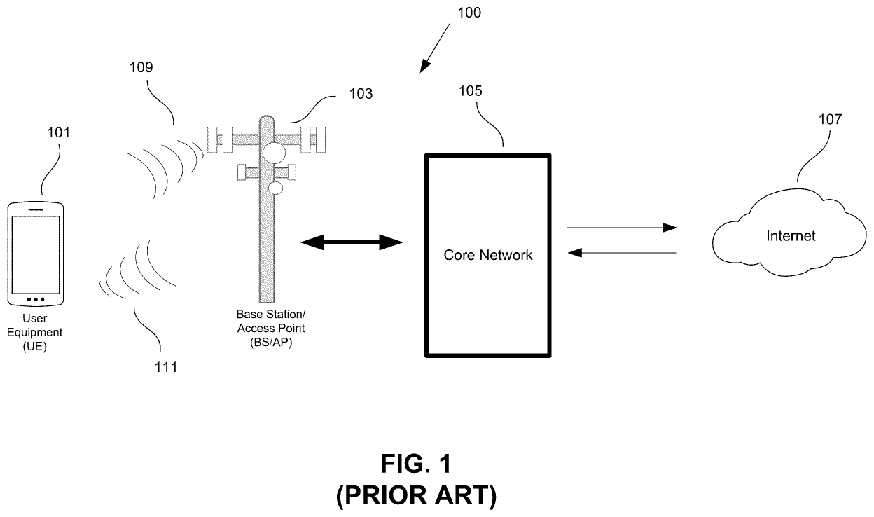

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

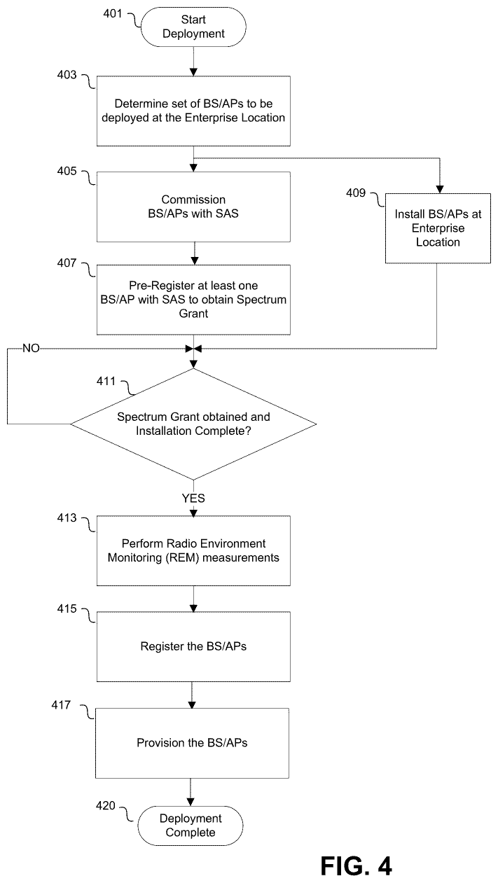

FIG. 4 is a flow chart that illustrates steps to deploy a plurality of BS/APs such as CBSDs (Citizen's Broadband radio Service Devices) in an enterprise network in accordance with the CBRS (Citizens Broadband Radio Service) interface specification. An enterprise network is one type of private network, and although described in the context of an enterprise network, the principles disclosed herein can also apply to any private network. Private networks are operated for use within a limited area by a limited group of authorized users, whereas public networks generally cover a larger area and are open for use by anyone that subscribes to the service by the network operator. An enterprise network is created at an enterprise location such as a warehouse, factory, research center or other building, and is usually operated by an organization for use by that organization. Other types of private networks may be operated by a private network manager for use by more than one organization.

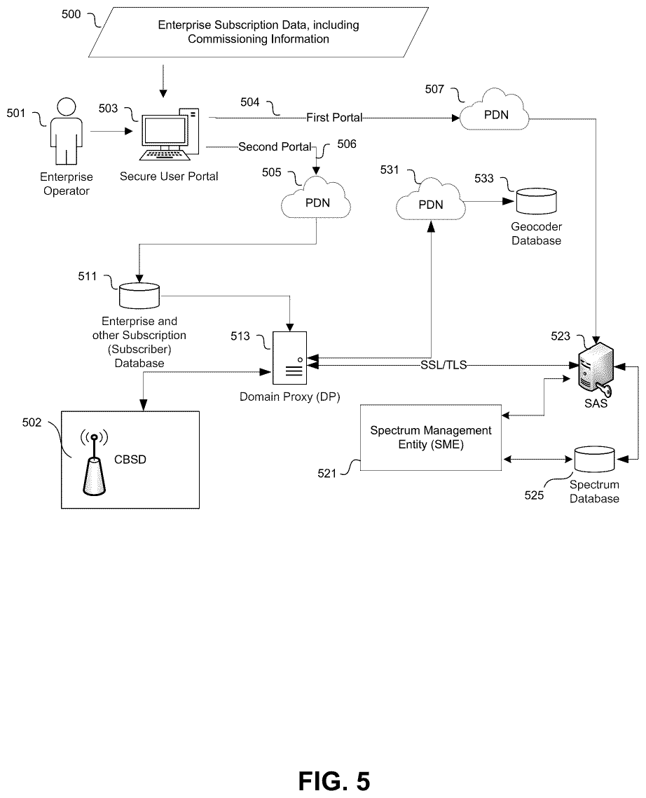

For purposes of description, the term deployment is used to describe the process by which the BS/APs in the network are set up to be ready for operation within the network. In the following, reference will be made to both the flow chart of FIG. 4 and block diagram of FIG. 5. FIG. 5 is a diagram of a communication system in which an enterprise operator provides subscription data and commissioning information to an SAS and a Subscriber Database.

A deployment operation for deploying a BS/AP starts at 401. An enterprise operator 501 or other appropriate organization or individual identifies the installation requirements and designs the network accordingly. Designing the network includes determining how many BS/APs (also referred to as CBSDs) will be required to provide service for a set of use cases and/or applications required by the enterprise and the locations of those BS/APs within the enterprise network (STEP 403). This determination may be made with the assistance of any appropriate planning tool. This determination (STEP 403) can be performed at a location remote from the enterprise location; i.e., it is not necessary for enterprise operator 501 or an access computer 503 coupled to one or more secure user portals 504, 506 through which the operator 501 communicates, to be physically located at the enterprise location, which advantageously allows remote management.

The network installation may be new or it could be an improvement to a previous installation. In either case, it is likely that new and/or updated BS/APs will be required. It should be noted that FIG. 5 does not depict any of the BS/APs, as they will typically not yet be present in the network. Once the number and location of the BS/AP 704APs have been determined (STEP 403), the necessary individual BS/APs can be purchased. This is typically necessary in order to attain and to provide identification information (i.e., to determine commissioning information 500) that is required to commission the BS/APs (STEP 405) and to perform pre-registration (STEP 407) for each of the BS/APs.

Advantageously, commissioning (STEP 405) and pre-registration (STEP 407) do not require that any of the BS/APs be physically installed or to transmit, which efficiently allows a significant portion of network setup to be performed before actual physical installation of the BS/APs within the enterprise location. In other words, installation of the BS/APs (STEP 409) can proceed in parallel with commissioning (STEP 405) and pre-registration (STEP 407), or at any convenient time.

Referring to FIG. 5, the BS/APs are commissioned (STEP 405) by the Spectrum Management Entity (SME) 521. The SME is coupled to the SAS 523 and a Spectrum Database 525. The commissioning stage (STEP 405) is one of the early steps in an enterprise deployment. As discussed above, this step typically occurs prior to BS/AP installation within the enterprise and the subsequent enterprise “bring-up” (i.e., the network being brought on line).

The access computer 503 is connected, via the first secure user portal 504 and a first Packet Data Network (PDN) 505 to the SAS 523. The PDN 505 is a generic network that provides data services. In some embodiments, packet switching involves data transmission wherein a message is broken into a number of parts that are sent independently, over whatever route is optimum for each packet, and reassembled at the destination. Utilizing the first secure user portal 504, the enterprise operator can use the access computer to securely transmit the collected commissioning information over the PDN 507 to the SAS 523. The commissioning information 500 includes subscription data relating to the enterprise and the BS/APs. Particularly, in a CBRS network, the commissioning information includes the number of CBSDs, the FCC Identification for each of the BS/APs, the transmission class of each of the CBSDs, the enterprise User Id, serial numbers of each of the CBSDs, their stock keeping numbers (SKU), and the physical address 112 where the enterprise CBSDs will be deployed. The commissioning information shown above is a minimum mandatory information and not exhaustive.

In FIG. 5, the access computer 503 is shown connected, via the second secure user portal 506 and a second PDN 507 to an Enterprise and other Subscription (Subscriber) Database 511 which is managed by a network operator/network manager, which may be a Certified Professional Installer (CPI), certified in accordance with the CBRC rules. Advantageously, by using the second secure user portal 506 to store subscription data in the subscriber database 511, the system can be made aware of the entire set of BS/APs that will belong to an enterprise much before the BA/APs are installed and powered on for the first time.

Referring to FIG. 5, a Spectrum Management Entity 521 is connected to and manages the SAS 523 and the Spectrum Database 525. The SME 521 must approve the commissioning information for each BS/AP, and the enterprise operator must ensure that the enterprise BS/APs, enterprise User Id, FCC Id and serial numbers of the BS/APs are approved with the SME 521. The enterprise operator 501 may achieve this approval process through the first secure user portal 504. Alternatively, this procedure may also be done on behalf of the enterprise operator by the network operator/network manager, utilizing the data stored in the Subscription Database 511 and the SSL/TLS connection between the Domain Proxy (DP) 513 and the SAS 523.

The methods indicated above for subscription data collection, commissioning and approval are simply an example and other variants are possible; for example, the network operator/network manager may perform any of these functions on behalf of the enterprise operator.

Referring again to FIG. 4, once the commissioning (STEP 405) is complete, pre-registration begins (STEP 407), in which at least one BS/AP is preregistered with the SAS 523 in order to get a spectrum grant for taking REM (Radio Environment Monitoring) measurements.

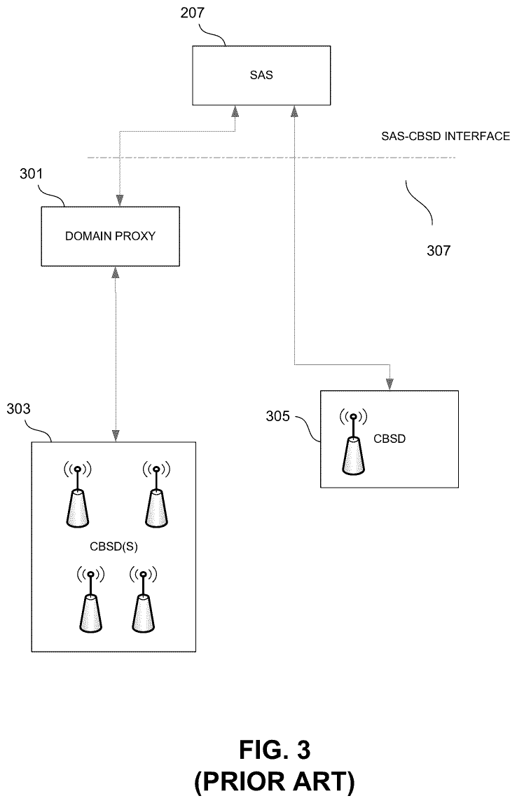

DPs and their advantages have been discussed and particularly with reference to the DP 301 discussed with respect to FIG. 3. Referring now to FIG. 5, the DP 513 acts as a proxy for all SAS transactions regarding the BS/APs. One advantage is that in large enterprise deployments, a DP is often deployed to minimize the high count of SSL/TLS connections that would otherwise be required for individual CBSDs. The DP 513 manages all the transactions by proxying the messages (i.e., acting to consolidate and relay individual messages in a proxy message) and facilitating functions such as channel arbitration, proxied heartbeat responses and so forth.

The DP 513 is connected to the subscriber database 511 to fetch subscription details from subscriber database 511. The DP 513 and subscriber database 511 are within the network operator's trusted environment. Accordingly, messages between them can be transmitted securely. Fetching (i.e., requesting information or information pushed out) may occur periodically, or on request, and may occur over any protocol. Alternately, the subscription database 511 may perform an event-based push, for e.g., when new enterprise details or updates existing enterprise details are entered into the database. The records fetched by DP 513 (or pushed into it) include enterprise details and the enterprise address. Contents of the records fetched may be used in the pre-registration process.

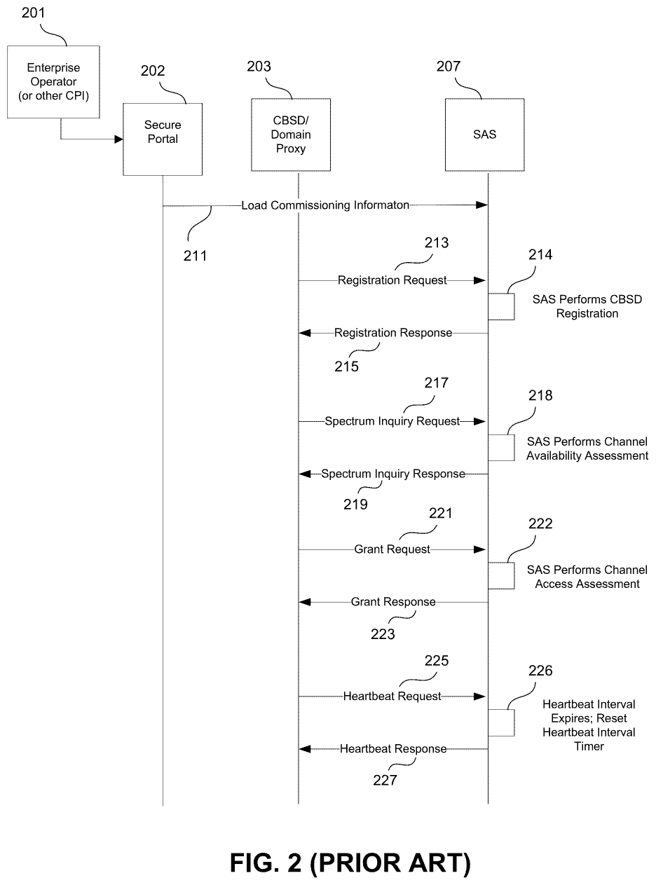

In pre-registration (STEP 407), the DP 513 initiates the registration process described with reference to FIG. 2, in order to obtain a spectrum grant. As part of the registration process the DP transmits a registration request to the SAS 523. As part of this request, the DP 513 (on behalf of the BS/AP) is mandatorily obligated to notify the SAS 523 of the BS/AP's location (in GPS coordinates). Without the location information, the SAS 523 will reject the registration. However, at the time the pre-registration process is initiated, the final position of the BS/AP is usually not known, and therefore the DP 513 cannot report a position to the required accuracy because it does not have a position yet. In order to report a position, the DP 513 obtains the address of the enterprise and connects to a geocoder database 533 via a third PDN 531. The geocoder 533 performs a reverse coding of the enterprise address (e.g., a Google geocoder) to obtain coordinates to provide with the registration request. The geocoder 533 converts the enterprise address into a coordinate location (e.g., latitude and longitude). It should be noted that the location accuracy at this point is relatively unimportant because the location is required only for reserving the weakest channel for use by the closest BS/AP in the enterprise, and because the resulting pre-registration spectrum grant will only be used for short periods while taking REM measurements, not for normal network operation.

As part of the registration request to the SAS 523, the DP 513 provides the enterprise “User ID” and a “groupParam object” with reason INTERFERENCE_COORDINATION. By setting the reason to INTERFERENCE_COORDINATION, the DP 513 indicates that it will manage channel arbitration (possibly including channel selection) and that SAS 523 should simply supply a list of frequency channels yet available from which to select.

To complete pre-registration (STEP 407) and receive a Spectrum Grant, the DP 513 and the SAS 523 exchange message flows beginning with the registration request 213 and continuing with the spectrum inquiry 217, spectrum grants 221 described with reference to FIG. 2 and in the CBRS interface specification. After pre-registration (STEP 407) is complete, the DP 513 has received a Spectrum Grant (STEP 411) that the DP 513 maintains for use in taking subsequent REM measurements (STEP 413). Particularly, at the end of the Grant Response 223, the Heartbeat Request message 225 is transmitted by the DP 513 for each BS/AP it had registered and continues to do so every Heartbeat Interval, even though the BS/APs are not transmitting and in some embodiments, may not even be powered-on.

Before operation can determine whether a Spectrum Grant has been obtained and installation is complete (STEP 411), the BS/APs must be installed in their location at the enterprise location installation (STEP 409). In this step, each BS/AP is installed at its desired location, connected to power, and may be tested to some extent. However, the BS/APs cannot begin to transmit until authorized by the DP 513. Each installation will have different requirements and may utilize different construction methods.

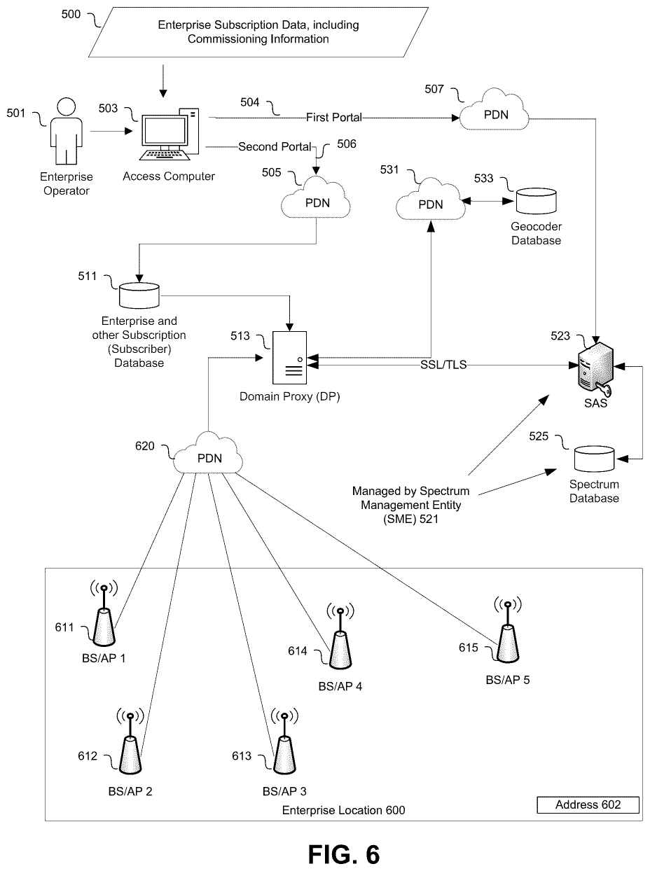

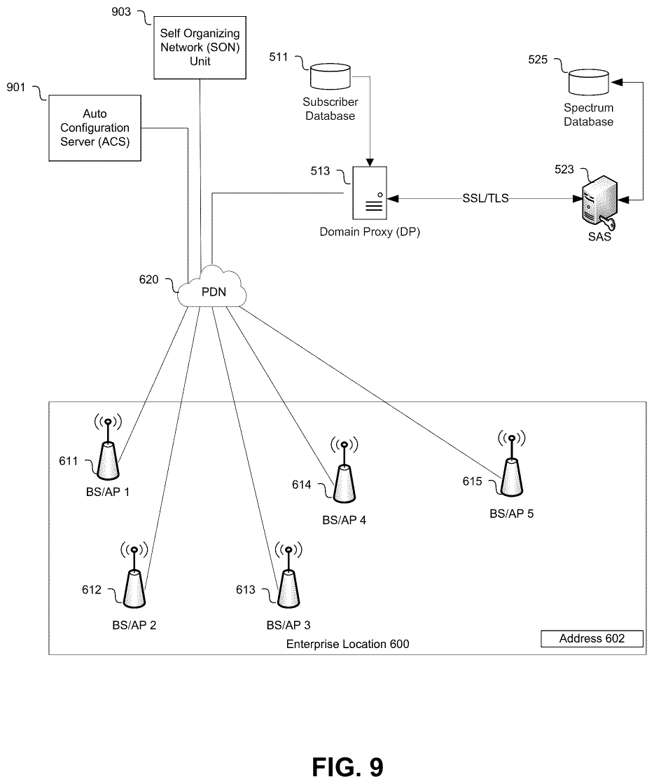

FIG. 6 is diagram that illustrates a plurality of BS/APs 611, 612, 613, 614, and 615 installed at an enterprise location 600 (STEP 409). As shown, the BS/APs 611, 612, 613, 614, and 615 are installed at the enterprise location that has an enterprise address 602, which is utilized in pre-registration (STEP 407). As shown, five BS/APs are installed, including BS/APs 611, 612, 613, 614, and 615; other implementations may include more or less BS/APs. As mentioned above, none of the BS/APs are allowed to begin transmission until instructed by the DP 513. The DP 513 may instruct the BS/APs directly or via an ACS (Auto Configuration Server) 901 (see FIG. 9). Each of the BS/APs 611, 612, 613, 614, 615 is connected via any appropriate connection (e.g., wireless, Ethernet, fiber optic, or other connection) to a fourth PDN 620, which is in turn connected to the DP 513.

Referring briefly back to FIG. 4, after pre-registration (STEP 407) and installation (STEP 409) are complete, and the DP 513 has a spectrum grant (STEP 411), operation can proceed to allow REM measurements to be taken (STEP 413). REM measurements are taken to learn the RF terrain. To do this, the BS/APs 611, 612, 613, 614, and 615 need to transmit on a frequency channel. The REM measurements are taken under the control of the DP 513. Before transmission can begin, the SAS 523 must allocate a channel to the enterprise network without knowing the BS/APs locations or measurements from the other BS/APs.

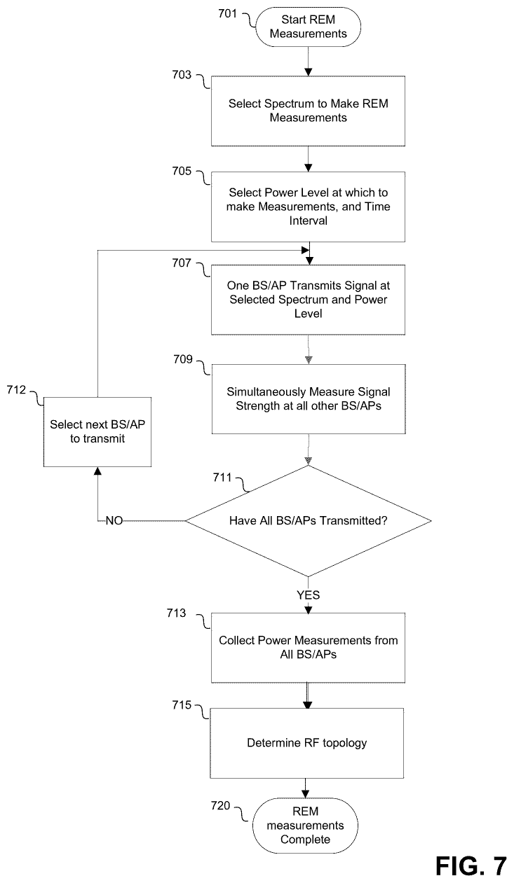

FIG. 7 is a flow chart that details the process for taking REM measurements (STEP 413). The process for taking REM measurements (STEP 413) begins (STEP 701) and the DP 513 selects a spectrum with which to take all the REM measurements (STEP 703). Note, the DP 513 may be aware of other CBRS band BS/APs that may already be in existence in the nearby area. If DP 513 is aware of nearby BS/APs, it performs an algorithm that determines the best frequency channel on which to take REM measurements by the enterprise BS/APs. The DP 513 ensures that all BS/APs operate within the specifications granted by the SAS 523 (e.g., that the BS/APs operate in frequency channels that are within the spectrum allocated by the SAS 523).

A power level and time interval is selected for the transmission of signals to be used in taking the REM measurements (STEP 705). Typically, the power level will be as high as possible without violating any known restrictions. The time interval may be typically on the order of a few seconds (e.g. 5-6 seconds), which is long enough to take REM measurements, but sufficiently short to avoid significant unintended interference with other systems nearby that may or may not be known to the DP 513. Alternatively, the time interval may be determined by monitoring the BS/APs that are not transmitting.

Next, one of the BS/APs transmits a signal at the selected spectrum and power level for the selected time interval (STEP 707). Simultaneously, the remaining BS/APs are made aware of the selected spectrum and measure the signal strength at their location (STEP 709). Next, a determination is made as to whether or not all the BS/APs have transmitted (STEP 711). If not, then the next BS/AP is selected to transmit (STEP 712), and the transmission and measuring (STEPS 707 and 709) are repeated. This round robin loop continues until all BS/APs have transmitted.

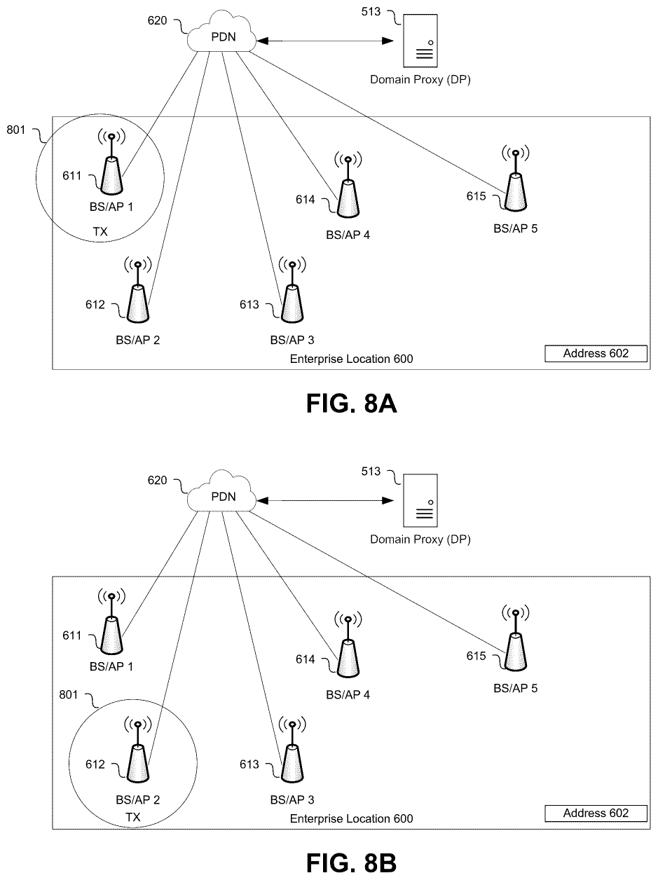

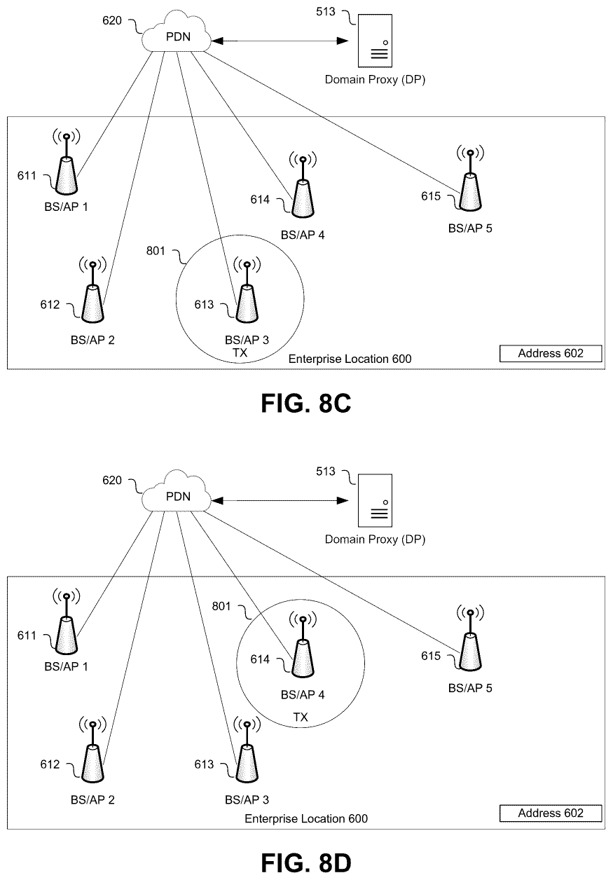

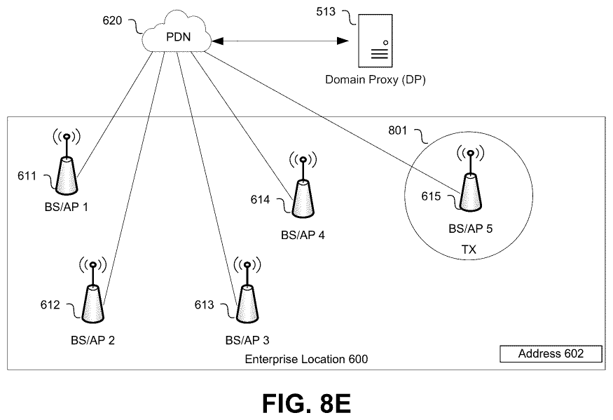

FIGS. 8A to 8E are a series of diagrams that show the round robin technique of taking REM measurements. In FIG. 8A, a circle 801 indicates that the first BS/AP 611 is transmitting on a selected spectrum, and the remainder of the BS/APs 612, 613, 614, 615 are listening to the same selected spectrum. In FIG. 8B, the circle 801 has been moved to the second BS/AP 612 to indicates that it is transmitting, and the remainder of the BS/APs 611, 613, 614, 615 are listening. This pattern continues similarly in FIG. 8C for the third BS/AP 613, in FIG. 8D for the fourth BS/AP 614, and in FIG. 8E for the fifth BS/AP 615. At that point, REM measurements have been taken from all BS/APs 611, 613, 614, 615 at the enterprise location. In addition to measuring the selected spectrum referred to above, each of the B S/APs may also be required to measure the RSSI of the entire CBRS band.

Referring to FIG. 7 and FIG. 9, the REM measurements that were taken (STEP 709) are from all the BS/APs 611, 613, 614, 615 (STEP 713). This step may be performed by an ACS 901. In some embodiments, the ACS 901 is connected via the fourth PDN 620 to the BS/APs 611, 613, 614, 615 in the Enterprise Location. The ACS 901 performs configuration management functions and in one embodiment resides in a Programmable Service Edge (PSE). The ACS 901 provisions the BS/APs using a protocol laid out in an industry standard presented in a document entitled “Technical Report 069” (TR-069). TR-069 is a technical specification published by the “Broadband Forum” that defines an application layer protocol for remote management of CPE (Customer Premises Equipment) connected to an IP (Internet Protocol) network. The Broadband Forum is a non-profit industry consortium dedicated to developing broadband network specifications. In some embodiments, the TR-069 protocol employs device models (“data-structures”) to provision one or more parameters at the BS/AP, such as setting 3GPP timers and constants, choosing algorithms implemented within a BS/AP, power control parameters, etc. In some embodiments, instead of TR-069, the ACS 901 may choose to provision the aforementioned operational parameters at the BS/AP using alternative methods such as SNMP.

During the round robin technique discussed earlier, each BS/AP is requested to transmit at a fixed (pre-determined) transmit power on the channel that was granted during pre-registration (STEP 407). During the round robin technique (STEP 413), each BS/AP that manages to “receive” the signal from the transmitting BS/AP, stores the measurements taken during REM in a data object. After the entire sequence of the round robin technique is completed, the ACS 901 fetches the data objects by for example performing a TR-069 GetParametersValue method on the data-object which houses the REM results from each BS/AP. GetParametersValue is a remote procedure call described in the standardized TR-069 protocol. In some embodiments, the ACS 901 may fetch the REM data-object via equivalent procedures using SNMP or any alternative.

The union of all REM data from all enterprise BS/APs is input into a SON (Self Organizing Network) Unit 903. The SON Unit 903 is connected via the fourth PDN 620 to the BS/APs in the Enterprise Location. Referring to FIG. 7, the union of all the REM data allows SON Unit 903 to determine a consistent “RF environment” and determine the neighbors of a given BS/AP (neighbor from a “radio” viewpoint and not necessarily Cartesian distance) (STEP 715).

With this knowledge, the SON Unit 903 can determine the separation in frequency that may be required between two “radio” neighbors. At the same time, the SON Unit 903 can identify “distant” BS/APs. In this context, a BS/AP is distant from other BS/APs if it can use (or re-use) the same channel as other BS/APs in the network without creating interference. For example, some BS/APs in the network may have unique antenna patterns which would allow the BS/APs to reuse the same channel. Alternatively, some BS/APs may be sufficiently far from one another that these BS/APs may reuse the same channel.

When the DP 513 receives channel availability information from the SAS following a Spectrum Inquiry procedure, the SON Unit 903 is also able to “allow” allocation of the same channel to two adjacent BS/APs, so long as it determines the “overlap” to be less than a predetermined power. In some embodiments, this can be derived based on strength of signal received from the adjacent BS/AP while taking REM measurements. The DP 513, in conjunction with the SON 903, can determine which channels are to be applied to each CBSD and transmits the Grant Requests appropriate for each CBSD to the SAS.

Allowing the selection/allocation of the same channel to adjacent BS/APs using the evaluations mentioned above creates an efficiency that makes additional spectrum available, even as BS/AP density increases within the enterprise.

One additional advantage of using a DP (other than the pre-registration) is that it can determine the “minimal” number of channels to operate an arbitrarily large enterprise network (with N BS/APs).

After the REM measurements have been taken and the SON Unit has performed its operations, the enterprise network is ready for normal operation. Before operation, each of the BS/APs must be registered as shown in FIG. 2, and as part of the registration process, the location of each BS/AP must be supplied in the registration request. Accordingly, the BS/APs must utilize their position location capability, and provide that information to the DP, which will then in turn provide it to the SAS in a registration request. The DP will then manage the registrations and spectrum grants for all the BS/APs and maintain the grants with heartbeat requests in accordance with standards. The BS/APs can then be wirelessly operated to transmit and open communication with any UE's that may be within their range for communication.

FIG. 2 is a flow diagram showing the communications that occur during registration. First, the Enterprise Operator (or other CPI) 201 commissions the CBSD 203 by loading information 211 regarding the CBSD 203 into the SAS 207 via a secure portal 202 in a database (not shown in FIG. 2) in the SAS 207. After all information has been entered 211 and approved, the CBSD 203 makes a Registration Request 213. The SAS 207 performs CBSD registration 214. The SAS 207 then sends a Registration Response 215. If registration 214 is successful, the CBSD 203 is in the registered state.

Once registered, the CBSD 203 can now make a Spectrum Inquiry Request 217. The SAS 207 performs a Channel Availability Assessment 218 and then sends the results to the CBSD 203 in a Spectrum Inquiry Response 219. Based upon the information in this response 219, the CBSD 203 requests a spectrum grant with a Grant Request 221. The SAS 207 then performs channel access assessment 222, and then sends a Grant Response 223. If spectrum is granted, the CBSD 203 must send a Heartbeat Request 225 to the SAS 207 before commencing transmission. At 226, the SAS 207 resets the Heartbeat Interval Timer and sends a Heartbeat Response 227 to the CBSD 203. The CBSD 203 can now commence transmission.

FIG. 3 illustrates advantages of using a DP. In a network that has multiple CBSDs 303, 305, a DP 301 acts as a proxy for all SAS transactions; particularly, the DP 301 manages all the transactions by proxying the messages and facilitating functions such as channel arbitration, proxied heartbeat responses, and so forth. Generally, a DP 301 is a logical entity that can represent one or more CBSD(s) 303 to the SAS 207. Advantageously the DP 301 presents a consistent and secure interface to the SAS 207 that can convey all messages pertaining to the SAS-CBSD interface 307 for client CBSDs 303. In large enterprise deployments, a DP 301 may be deployed to minimize the high count of SSL/TLS connections that would otherwise be required for individual CBSDs, such as the CBSD 305.

In any network deployment, after the BS/APs are installed, it is necessary to understand the RF environment in order to properly assign channels and reduce interference. This is particularly important in the CBRS band, because several radio access technologies, such as 4G LTE and 5G NR, can be deployed within the same band, as well as PAL uses and incumbent users being present in the spectrum. If the network is operating on an LTE network, the RF environment must be known before the correct frequency channels and other operational parameters can be assigned, such as assignment of a Physical Cell Identity (PCI). Furthermore, CBRS has an established hierarchy in which incumbent entities have the highest priority, PAL (Priority Access License) entities have the next highest priority, and GAA (General Authorized Access) entities have the Lowest priority. Incumbents include entities such as the Department of Defense radar systems, etc.

A DPA (Dynamic Priority Area) event occurs when an incumbent that was not previously present starts transmitting. Due to the high priority of incumbents, all PALs and GAAs must clear a channel upon which an incumbent begins transmitting (i.e., upon the occurrence of a DPA). The SAS 207 through which a CBSD registered provides messaging to indicate the occurrence of a DPA to any affected CBSD.

In accordance with some embodiments of the disclosed method and apparatus, an SME (Spectrum Management Entity) 521 (see FIG. 5) receives an indication informing the SME 521 of the occurrence of the DPA. In some embodiments, the SME 521 is referred to as a SON (Self Organizing Network). Upon being informed of a DPA, the SME 521 performs a “Reallocation” procedure. During a Reallocation procedure, the SME 521 identifies which channels are available for the CBSDs currently transmitting on channels that must be cleared.

In some embodiments, the SME 521 performs the following the following:
The SAS 523 triggers a DPA event;
The DP 513, having maintained a record of which channels were available when the initial request was made, determines which channels are available for that CBSD 502;
DP 513 is provided a channel and a power level that is available from the SME 521;
SME 521 calculates the neighbor group and the channels being used by the neighbors;
SME 521 assigns the channel that will be optimal to use for the CBSD 502;
If an orthogonal channel is available, it is used. If no such orthogonal channel is available, the channel that is used the least by a neighboring CBSD 502 is used. A ranking list for all the CBSDs 502 is generated based on the used-Channel count and based on that ranking the channel is assigned.
SME 521 calculates the max power at which the CBSD 502 should operate (should be less than the maxEirp given by SAS 523);
SME 521 calculates the PCI (Physical Cell ID) to be assigned by avoiding PCI collations;
SME 521 calculates the new neighbor list to be assigned to that CBSD 502;
DP requests grants on the channel that the SME 521 provided;
Once a grant is authorized the DP configures the CBSD 502 with the parameters and brings the CBSD 502 on line;
If the DPA is released, the original channel that was assigned is used; and
The procedure is repeated for any suspension/termination.

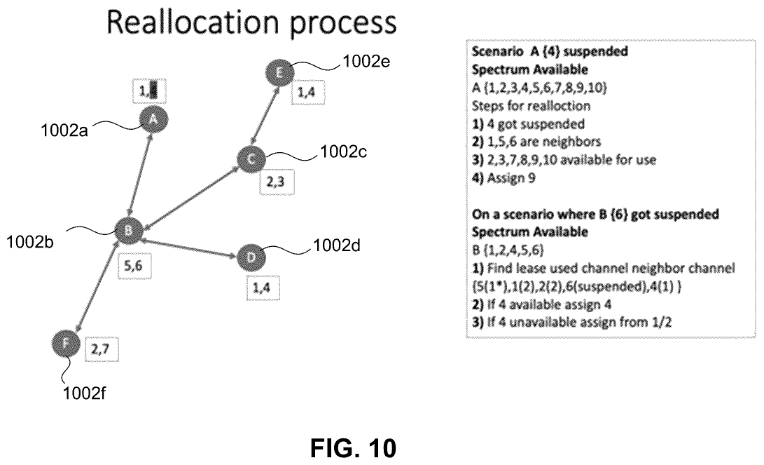

FIG. 10 represents the relationship between CSBDs 1002. Six CBSDS 1002 are shown. It should be noted that for elements having a reference designation having both a numeric and alphabetic component, other such elements having a reference designation with same numeric portion are instances of a similar element. For example, 1002a and 1002b are both similar CBSDs. Furthermore, a group of such elements can be referenced by the numeric portion of the reference designation along. For example, all such CBSDs can be referenced collectively as the CBSDs 1002.

As shown, a first CBSD 1002a has two sectors. In some embodiments, a first radio that can transmit and receive signals independently from a second radio, the first radio communicating with different UEs then the second radio, both radios being essentially collocated within the same CBSD 1002. Typically, such radios have directional antennas that are pointed in different directions, and each operates on a different transmit and receive frequency from the other.

The first sector is operating on channel 1 and the second sector is operating on channel 4. Similarly, a second CBSD 1002b has two sectors, one operating on channel 5 and one operating on channel 6. The arrow 1004 between these two CBSDs 1002a, 1002b indicates that they are neighbors. It should be noted that spacing of the CBSDs 1002 shown in figure is not representative of the physical distance between the CBSDs 1002. Rather, the definition of “neighbor” is at least in part based upon the physical distance between two CBSDs 1002. In addition to the distance between the CBSDs 1002, whether each CBSD 1002 is located indoors or outdoors determines the threshold distance at which the two CBSDs 1002 are considered to be neighbors. Other factors, such as whether the sectors of the two CBSDs are pointed at each other (i.e., the relative direction in which each sector is pointed) and the azimuth of the transmission of any two CBSDs 1002 will impact whether the two are neighbors. In FIG. 10, the CBSD 1002b has four neighbors (i.e., 1002a, 1002c, 1002d, 10020, whereas CBSD 1002c has two neighbors (i.e., 1002b and 1002e) and the other four CBSDs 1002a, 1002d, 1002e, 1002f each have only one neighbor.

FIG. 2 further illustrates that channel 4 used by CBSD 1002a and represented as A{1} has been suspended (as a consequence of a DPA event). The channels that the SAS 523 indicated were available to the CBSD 1002a are channels 1 through 10, represented as A{1,2,3,4,5,6,7,8,9,10}. It should be noted that even though channel A{4} has been suspended, it remains in the list of available channels. The SME 521 determines that the neighbors are using channels 1, 5 and 6. It should be noted that channel 1 is included in the list because it is being used by the other sector in the CBSD 1002a and channels 5 and 6 are listed because they are being used by the neighboring CBSD 1002b. Accordingly, the channels from which the SME 521 will select a new channel to reallocate the sector of the CBSD 1002a that is currently operating on channel 4 will include channels 2, 3, 7, 8, 9 and 10. Note that neither channel 4 (which was suspended) nor channels 1, 5 or 6 (which are being used by neighbors) are in this list. The SME 521 selects channel 9 from this list. The choice of channel 9 from among the channels 2, 3, 7, 8, 9 and 10 is essentially arbitrary.

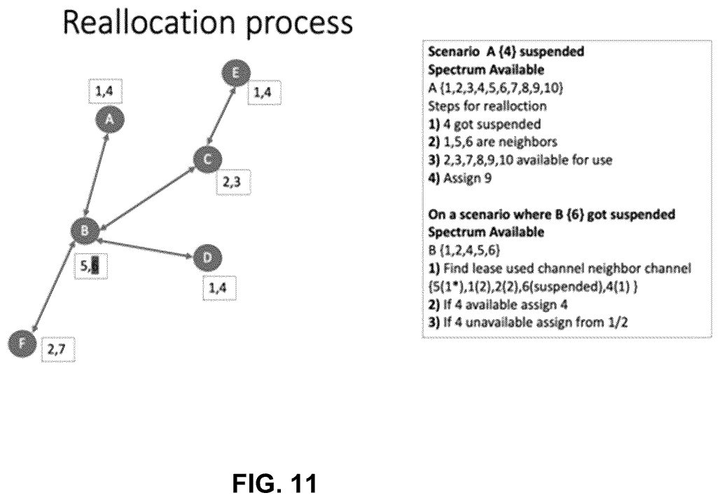

In a second scenario shown in FIG. 11, channel B{6} is suspended. The available channels include B{1,2,4,5,6}. In this case, each of these channels is being used by a neighbor. That is, channel 1 is being used by CBSD 1002d, channel 2 is being used by the CBSD 1002f, channel 4 is being used by the CBSD 1002d and channel 5 is being used by the other sector of CBSD 1002b. In addition, note that channel 6 is the suspended channel. Therefore, the decision as to which channel to reallocate to the sector of CBSD 1002b is made based on the channel that use the least. Channel 5 is used only once and that use is by the other sector in the CBSD 1002b, as represented by 5(1), wherein “5” indicates the channel, “1” indicates the number of times the channel is currently being used by a neighbor, and “ ” indicated that the use is by the other sector in the same CBSD 1002b. Similarly, 1(2) (i.e., channel one is used twice), 2(2), 6(suspended), 4(1). Therefore, since channel 4 is available and is the least used channel, it is selected as the channel to which the sector of the CBSD 1002b that previously used channel 6 will be reallocated.

The following describe how a neighbor list is configured for a CBSD 1002 for indoor and outdoor scenarios. For indoor CBSDs 1002, the SME 521 populates a neighbor list based on the CBSD deployment calculations made on the day the CBSD 1002 was initially deployed. If that information is unavailable, the SME 521 calculates the neighbor list based on the latitude and longitude of the CBSD 1002. If the CBSDs 1002 are 150 feet or less, then they are defined as neighbors.

For outdoor CBSDs 1002, an external portal is opened to allow a user to edit the neighbor list. If such a portal is unavailable, the SME 521 calculates the neighbor list based on the latitude and longitude. If the APs are 2000 feet or less, they are defined as neighbors.

In some embodiments, if a channel operates at a quality below a predetermined threshold, or has been suspended frequently (as determined by data collected), such channels are masked from being used and when performing allocation or reallocation procedures in future, those channels are removed from eligibility.

The following is provided merely as one example of how a process might be performed:

Suspension (code 501);

```
  First suspension with IAP pending;
  Suspension due to DPA activity;
```

Termination (code 500/400);

```
  PAL activity;
  Incumbent activity;
```

Suspension

Is operation parameter present (only available on FW, not on google)

OperationParam {

MaxEirp
OperationFrequencyRange
}

For (CBSD ID)

```
Get operating power
    If Power >= MaxEirp
      Ask grant on the OperationFrequencyRange
    If not present
      For (CBSD ID)
        Get available spectrum
        Get available power
        Ask assist for a new channel
        Get new channel
        Ask grant on the new channel
          If grant on DPA
            Check for IAP pending
              Yes (wait for 10 hbt)
              No (ask for a second channel)
```

Termination

Is operation parameter present (only available on FW, not on google)
Same as Suspension (a)
If not present

```
For (CBSD ID)
    Get available spectrum
    Get available power
    Ask assist for a new channel
    Get new channel
    Ask grant on the new channel
    If grant on DPA start suspension loop (1)
```

For SME assist:

On Service initialization

Get all serials assigned to the PSE
Get sites for all serials
Find if CPI info present for the serials
Create location-based edges

On Channel allocation

Check for SONv2 channels

If valid Allocate channels and power
If not, valid Domain proxy sends alert for invalid channel allocation

Else

```
If location-based edges already formed
    Allocate channels based on that
      Priority on top 50
      Priority on max power channel
      Use Max BW
Else
    Do step c, d from 1
    Do step b from 2
Indoor - Edges If SONv2 edges already present from edges based on that
Outdoor - CLI based
```

On channel reallocation

Get the edges to that node
Get available spectrum
Get power available
Traverse the edges and find the channel not assigned

```
If any from available channel not assigned
    Assign the new channel
Else
    Assign the channel least used by neighbors
Assign new PCI to the channel
Assign new RSI to the channel
Assign power assigned by SONv2
    If not available assign the old power.
```

| 1. | Two new sites were created | |
|---|---|---|
| | Site 1 {S1,S2,S3,S4,S5} | |
| | Site 2 {S6,S7,S8,S9} | |
| 2. | CPI info entered | |
| 3. | CBSD registered | |
| 4. | Available Spectrum(power) | |
| | a. | 1(20),2(20),3(20),4(20),5(20),6(20),7(20),8(20) |
| 5. | Send info to SON | |
| | a. | S1->S1,S2,S3 (each CBSD has two sectors) |
| | b. | S2->S2,S3 |
| | c. | S3->S3,S1,S4 |
| | d. | S4->S4,S5 |
| | e. | S5->S5,S4 |
| 6. | Allocate channel and power | |
| | a. | S1(1)->S1(2), S2(3,4),S3(4,5) |
| | b. | S2(3,4)->S2, S1(1,2) |
| | c. | S3(3,4)->S3, S1, S4(1,2) |
| | d. | S4(1,2)->S4, S5 (3,4) |
| | e. | S5(3,4)->S5, S4 |
| 7. | Suspension/Termination on S2 Radio 2 | |
| | a. | Reallocation triggered from domain proxy |
| | b. | Channels available { 1(20),2(20),3(20), 8(20)} |
| | c. | Check for neighbors |

| | |
|---|---|
| i. | S2 Radio 1 and S1 |
| ii. | Channels used 1,2,3 |
| iii. | Allocate channel 8 (if only channel 1,2,3 was available, 1 or 2 |
| | would be priority of allocation since 3 is used on same AP) |

| | |
|---|---|
| d. | Send new channel to domain-proxy for grant |
| e. | Get new grant |
| f. | Allocate channel to AP |

In some embodiments, the same channel is never reused on the same CBSD unless it is manually configured to do so.

Furthermore, in some embodiments, if only 10 MHz is available, the system will operate only a single radio.

If no grant available, then the system will wait for the suspension to be lifted.

In some embodiments, PCI allocations 1-300, 304-504 are held, since indoor and outdoor PCI allocations are maintained separate, with the indoor PCI range from 1-300 being isolated from outdoor PCI range from 304-503. This is done to ensure that on a mixed deployment (indoor+outdoor) CBSDs, when the power calculation is different for indoor and outdoor the indoor and outdoor PCIs can be isolated without computing them together and getting the PCI coalitions. Furthermore, DPA counters are captured per sector of each CBSD for further analysis and determining which channel is least disrupted. In addition, a counter is maintained for counting the number of reallocations that have been triggered over a predetermined period of time.

### PAL Channel Reallocation on DPA

In some embodiments, PAL channels are prioritized for reallocation in the 3550-3650 MHz during a DPA event.

### REQUIREMENTS/CONSIDERATIONS

In some embodiments, the following requirements/considerations can be used to determine the preferred choice of a solution upon a DPA event.
PAL channels are prioritized for reallocation within the 3550-3650 MHz PAL channel reallocations to [3650-3700] MHz is not supported.
Minimize the ripple of GAA channel reallocations caused due DPA and confine it to the minimum necessary.
Minimize the fragmentation of GAA channels being allocated to the different CBRS

Users and allocate contiguous spectrum when possible.
Ensure the availability of the channels unused by a given CBSD Users to be equally available to all GAA CBSD Users.

The following is a simplified method for reallocation of PAL channels upon occurrence of a DPA.
Step 1: Move PAL to GAA to unused channel within the [3550-3700] MHz range and that is not impacted by DPA. Move to the next step only if this is not successful.
Step 2: Move PAL to GAA used by the same CBSD User. Move to the next step only if this is not successful.
Step 3: Move PAL to another CBSD User GAA channel allocation while reallocating it to another GAA channel in [3550-3700] MHz range.
Step 4: Treat the PAL reallocation just as another GAA channel for operations.
Step 5: Recompute the PPA (PAL Protection Area; area that is a distance away from the AP using PAL) only when the demands of the PAL CBSD are not met and reported by the CBSD for a sustained period of time [TBD]. The SAS assess the need to recompute the DPA based on the past experienced statistics of the DPA in the location/region and the extend of impact caused by the GAA CBSDs on the reallocated PAL channel.
Step 6: If the DPA is released, move the full neighborhood to the prior allocations for both PAL and GAA channels.
Step 7: Upon repeated DPA impacts to a specific PAL channel, the PAL CBSD User can request the SAS to have the allocation moved to a more appropriate channel. This recommendation can be provided by the SAS entities proactively as well.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method comprising:
a) determining a set of Base Stations/Access Points (BS/APs) to be deployed at an enterprise location;
b) commission BS/APs with SAS (Spectrum Access System);
c) pre-register at least one BS/AP with SAS to obtain spectrum grant;
d) upon receipt of spectrum grant, monitoring the radio environment to perform an REM (Radio Environment Monitoring) operation and attain REM measurements;
e) register the BS/APs; and
f) provision the BS/APs.
